(19) United States
(12) Patent Application Publication
(10) Pub. No.: US 2026/0063525 A1
(43) Pub. Date: Mar. 5, 2026

(54) TEST METHOD FOR QUANTITATIVELY STUDYING STRESS WAVE PROPAGATION LAW OF POROUS ROCK

(71) Applicant: Shenzhen University, Shenzhen (CN)

(72) Inventors: JIANBO ZHU, Shenzhen (CN); TAO ZHOU, Shenzhen (CN); HEPING XIE, Shenzhen (CN); JUNFENG TAN, Shenzhen (CN); WEIYUE BAO, Shenzhen (CN); JUNYAN LI, Shenzhen (CN); SHIWEI ZHANG, Shenzhen (CN); ZHUO CEN, Shenzhen (CN); CHENGCHENG XIE, Shenzhen (CN); LINSHENG LIANG, Shenzhen (CN)

(21) Appl. No.: 19/209,020

(22) Filed: May 15, 2025

(30) Foreign Application Priority Data
May 29, 2024 (CN) 202410674547.3

(51) Int. Cl. G01N 3/317; G01N 3/04

(52) U.S. Cl. CPC G01N 3/317; G01N 3/04; G01N 2203/001; G01N 2203/005; G01N 2203/0098; G01N 2203/0256; G01N 2203/0298; G01N 2203/0405

(57) ABSTRACT

The invention provides a test method for quantitatively studying a stress wave propagation law of a porous rock, which adopts a dynamic true triaxial electromagnetic Hopkinson bar test system for testing. The test method comprises: quantitatively designing and preparing a cubic porous rock sample required by testing; placing the cubic pore rock sample in a central cubic square chest; and quantitatively studying a high-amplitude stress wave propagation law of the porous rock on the cubic porous rock sample by adopting the dynamic true triaxial electromagnetic Hopkinson bar test system.

### CROSS-REFERENCE TO RELATED APPLICATIONS

This application claims priority to Chinese Patent Application No. 202410674547.3, filed on May 29, 2024, which is hereby incorporated by reference in its entirety.

### TECHNICAL FIELD

The present invention relates to the technical field of high-amplitude stress wave propagation law analysis, in particular to a test method for quantitatively studying a stress wave propagation law of a porous rock.

### BACKGROUND

When geological activities occur inside the crust, earthquakes usually occur, because the movement of the crust releases energy and produces seismic waves. The seismic waves propagate inside the earth and interact with rocks. However, interiors of the rocks usually contain a large number of holes, cracks and joints, which will affect propagation modes and characteristics of the seismic waves. Generation and propagation mechanisms of earthquakes can be better understood by studying stress wave propagation laws in the porous rocks. Therefore, it is of great significance to study the stress wave propagation laws in the rocks for understanding and coping with natural disasters such as earthquakes, which is helpful to improve an ability of the society to cope with earthquake disasters and reduce losses caused by the disasters.

At present, Hopkinson bars are mostly used in quantitative studying on the stress wave propagation law of the rocks on concrete and other materials. The Hopkinson bars can only complete the studying of uniaxial high-amplitude stress wave propagation and attenuation laws. However, natural rocks are anisotropic, and porous rocks are often subjected to high-amplitude stress in many directions. However, under the existing studying, it is impossible to study high-amplitude stress wave propagation and attenuation laws of the porous rocks in multi directions by using the existing devices and technologies, and it is also impossible to further quantitatively study the high-amplitude stress wave propagation and attenuation laws of the porous rocks under the above triaxial action by using the existing devices and technologies. Therefore, it is urgent to develop a test method to make up for the blank of the study on the high-amplitude stress wave propagation laws in rock porous media.

In addition, due to the non-repeatability of the rocks in nature, it is difficult to quantitatively design and repeatedly prepare rock samples with complex pores in the existing studying, which also restricts the quantitative study of the stress wave propagation properties of the porous rocks.

### SUMMARY

In order to solve the problems in the prior art, the present invention provides a test method for quantitatively studying a stress wave propagation law of a porous rock, which improves an existing Hopkinson bar system to obtain a dynamic true triaxial electromagnetic Hopkinson bar test system that can realize analysis study on high-amplitude stress waves. In addition, by utilizing the advantages of programming software and 3D printing technology, rock samples with complex porous media are designed and manufactured respectively, which can make up for the deficiency of not being able to quantitatively design rock samples and help to analyze the high-amplitude stress wave propagation and attenuation laws in the porous rock from a quantitative point of view.

The test method for quantitatively studying the stress wave propagation law of the porous rock adopts a dynamic true triaxial electromagnetic Hopkinson bar test system for testing, wherein the dynamic true triaxial electromagnetic Hopkinson bar test system comprises a horizontal cross supporting platform, and a central cubic square chest arranged in a middle part of an upper surface of the horizontal cross supporting platform, and further comprises a dynamic true triaxial electromagnetic Hopkinson bar and a test device;
X+ direction, Y+ direction and Z+ direction square bars of the dynamic true triaxial electromagnetic Hopkinson bar are square incident bars, X− direction, Y− direction and Z− direction square bars are square transmission bars, one sides of the X+ direction, Y+ direction and Z+ direction square bars near an incident stress wave loading end are each provided with one first boss, rear ends of the X− direction, Y− direction and Z− direction square bars away from the X+ direction, Y+ direction and Z+ direction square bars are each provided with one second boss, and rear ends of the second bosses are each provided with one square buffer bar with a cross-section size same as that of X direction, Y direction and Z direction square transmission bars to realize centration with the square bar in the same direction, an X− direction square buffer bar, a Y− direction square buffer bar and a Z− direction square buffer bar are respectively fixed by self-lubricated square buffer bar fixing and supporting frames, a rear side of the square buffer bar is further provided with one energy absorbing and buffering device for absorbing energy transferred by the buffer bar;
the square incident bars in the X+ direction, the Y+ direction and the Z+ direction and the square transmission bars in the X− direction, the Y− direction and the Z− direction of the dynamic true triaxial electromagnetic Hopkinson bar are respectively fixed on the horizontal cross supporting platform by the self-lubricated square bar fixing and supporting frames, and the square incident bars and the square transmission bars are centered and connected with the central cubic square chest in a square opening; and
the test device comprises an electromagnetic pulse emitting device arranged in an incident direction of the square incident bar, a static pre-stress applying device arranged in an output direction of the square transmission bar, and stress detecting elements respectively arranged on the X+ direction, Y+ direction, Z+ direction, X− direction, Y− direction and Z− direction square bars used for measuring stress wave signal data.

The test method comprises the following steps:
step 1: quantitatively designing and preparing a cubic porous rock sample required by testing;
step 2: placing the cubic pore rock sample in the central cubic square chest, wherein the central cubic square chest and the horizontal cross supporting platform form an orthogonal coordinate system for accurately positioning and centering the dynamic true triaxial electromagnetic Hopkinson bar and six surfaces of the cubic porous rock sample; and
step 3: quantitatively studying a stress wave propagation law of the porous rock on the cubic porous rock sample by adopting the dynamic true triaxial electromagnetic Hopkinson bar test system, wherein:
in the step 1, a method for quantitatively designing and preparing a cubic porous rock sample required by testing comprises:
step 101: establishing a sample three-dimensional model data plane: establishing a cubic three-dimensional model with arbitrary spatial distribution of pores with a set shape based on a MATLAB programming tool, and acquiring a file containing sample three-dimensional model data plane information;
step 102: converting the three-dimensional model data plane into a three-dimensional solid: converting the sample three-dimensional model data plane of the file into the three-dimensional solid, and processing the three-dimensional solid to obtain a qualified sample three-dimensional solid model containing pores; and
step 103: performing slicing and 3D printing processing of the model: slicing the processed file of the sample three-dimensional solid model, setting a non-porous medium part in the sample to be cured and a porous medium part to be non-cured, acquiring a code file which is recognized by a 3D printer, and then inputting the code file to the 3D printer for 3D printing, and finally obtaining the cubic porous rock sample for experimental testing.

Further, the electromagnetic pulse emitting device comprises first confining pressure loading frames respectively arranged in incident directions of the X+ direction, Y+ direction and Z+ direction square incident bars and are connected in series with the first boss, the first confining pressure loading frame is provided with an electromagnetic pulse excitation cavity, the electromagnetic pulse excitation cavity is capable of applying a high-amplitude stress wave to the square incident bar and is sequentially transferred to a sample to be tested and the square transmission bars through the square incident bars; and

the static pre-stress applying device comprises a confining pressure loading cylinder, a confining pressure loading actuator and a second confining pressure loading frame, the confining pressure loading cylinder and the confining pressure loading actuator are respectively combined in series with the second confining pressure loading frame, and the second confining pressure loading frame is connected in series with a second boss for transferring an acting force of the confining pressure loading cylinder to the square bars and a sample for testing.

Further, the stress detecting element is a strain gauge or a strain sensor.

Further, in the step 3, a method for quantitatively studying the stress wave propagation law of the porous rock on the cubic porous rock sample by adopting the dynamic true triaxial electromagnetic Hopkinson bar test system comprises:
step 301: placing an X+ direction electromagnetic pulse excitation cavity and an X+ direction electromagnetic pulse excitation cavity supporting frame in an X+ direction confining pressure loading frame, and placing the same at an incident end of the X+ direction square incident bar to ensure that the X+ direction electromagnetic pulse excitation cavity is closely attached to the incident end of the square incident bar, and make the square incident bar and the square transmission bar be closely attached to the sample near the cubic porous rock sample side, in the case of not applying a static pre-stress, applying a high-amplitude dynamic stress wave by using the X+ direction electromagnetic pulse excitation cavity, and using the stress detecting elements on the X+ direction square incident bar and the X− direction square transmission bar to record and save complete stress wave signal data in the X direction after applying the high-amplitude dynamic stress wave under the condition of not applying a static pre-stress, and similarly carrying out same operations on Y and Z directions at the same time to acquire complete stress wave signal data in the Y and Z directions after applying a high-amplitude stress wave under the condition of not applying a static pre-stress;
step 302: applying a static pre-stress, opening a high-pressure oil pipe, charging oil into an X− direction confining pressure loading cylinder through an oil inlet, and pushing an X− direction confining pressure loading actuator to move forward and contact with an X− direction confining pressure loading frame; and continuously applying an oil pressure to push the X− direction confining pressure loading actuator to move forward, transferring an axial pressure to the X− direction square transmission bar through an X− direction second boss, and then acting on the cubic porous rock sample, so that the cubic porous rock sample is statically pre-stressed in the X direction, similarly, static confining pressure loading principles in the Y and Z directions being the same as that in the X direction; and
step 303: applying a high-amplitude dynamic stress wave to the X+ direction, Y+ direction and Z+ direction electromagnetic pulse excitation cavities respectively to acquire stress the complete wave signal data in the X, Y and Z directions after applying the high-amplitude dynamic stress wave under the condition of applying a static pre-stress.

Further, the method further comprises step 304: adjusting an amplitude of the stress wave and/or the static pre-stress respectively, and analyzing different high-amplitude stress wave propagation and attenuation laws in a certain cubic porous rock sample based on the complete stress wave signal data in the X, Y and Z directions acquired under the conditions of not applying a static pre-stress and applying a static pre-stress more than once.

Further, the method further comprises step 305: switching different cubic porous rock samples, and returning to execute steps 301-304 to analyze the high-amplitude stress wave propagation and attenuation laws of a plurality of porous rocks in multiple dimensions by using a plurality of groups of stress wave signals.

Further, in the step 301, a processing manner for applying the high-amplitude dynamic stress wave to the X+ direction comprises:
applying a high-amplitude dynamic stress wave to the sample for testing at the incident end of the X+ direction square incident bar, wherein the dynamic stress wave is transmitted to the X+ direction square incident bar as an X+ direction stress wave via a left end face of the X+ direction square incident bar, and then the X+ direction stress wave is propagated from the X+ direction to the X− direction to the cubic porous rock sample along an axis direction of the X+ direction square incident bar and propagated to the X− direction square transmission bar as an X− direction transmitted stress wave; after receiving the X− direction transmitted stress wave, the X− direction square transmission bar moves backward and hits the X− direction square buffer bar, and transfers energy to the X− direction square buffer bar at the same time; the X− direction square buffer bar moves backward and hits an X− direction energy absorbing and buffering device therebehind, and the X− direction energy absorbing and buffering device absorbs all the energy to prevent the X− direction square buffer bar from moving in an opposite direction and hitting the X− direction square transmission bar, thus completing one complete X direction loading.

Further, for the collected data, a reflection coefficient of each impact in three directions is calculated according to a formula

$$R = \frac{{A}_{r}}{{A}_{0}} ,$$

wherein A₀ is an amplitude of an incident wave signal, and Aᵣ is an amplitude of a reflected wave signal; a transmission coefficient of each impact in three directions is calculated according to a formula

$$T = \frac{{A}_{t}}{{A}_{0}} ,$$

wherein A₀ is the amplitude of the incident wave signal, and Aₜ is an amplitude of a transmitted wave signal; meanwhile, the transmitted wave signals in three directions are respectively imported into Python or MATLAB software for frequency analysis; firstly, the signals are normalized, a window function after normalization is selected according to signal characteristics, then the data are subjected to windowing, and fast Fourier transform is carried out on the data after windowing to convert the data in original time domain of the transmitted signals into data in frequency domain, and data of positive axis is intercepted for drawing to understand distribution and change laws of transmitted wave energy in a frequency range.

Further, in the step 101, a code for generating the cubic porous rock sample three-dimensional model is written by using the MATLAB programming tool, the MATLAB programming tool is preset with a series of parameters for controlling the rock sample, and through the setting of the parameters, a corresponding STL format file of the sample three-dimensional model data plane is obtained to realize accurate quantitative control of the porous medium characteristic of the cubic porous rock sample, wherein the parameters comprise one or all of a size of the cubic porous rock sample, a shape of the pore inside the sample, a pore size, spatial distribution, a size range and a porosity.

Further, the shape of the pore inside the sample comprises a spherical shape, a coin shape, an ellipsoid shape, a polyhedron shape or an irregular anisotropic shape, and when the shape of the pore is the spherical shape, a method for generating the cubic porous rock sample three-dimensional model STL file comprises the following steps:
A1: starting, and acquiring the input parameters for controlling the rock sample;
A2: generating three-dimensional data of the rock sample with corresponding shape and size;
A3: generating corresponding spherical pore spherical data according to the input parameters;
A4: calculating a porosity, determining whether the porosity is within a set interval, if yes, deriving porous data and then executing step A5, if not, returning to executing step A3; and
A5: exporting the porous data, and writing the three-dimensional data of the rock sample and the porous data into the STL format file, and ending.

Compared with the prior art, the present invention has the beneficial effects as follows:

According to the present invention, by innovating the existing electromagnetic Hopkinson bar, three directions of the three axes are respectively taken as incident bars and the other three directions are taken as transmission bars, and the incident stress wave, the reflected stress wave and the transmitted stress wave signals can be effectively separated, thus providing basic conditions for realizing the study of three-way high-amplitude stress waves.

A phenomenon of inaccurate measurement caused by the square buffer bar moving in the opposite direction and hitting the square transmission bar when applying an impact load is avoided by setting a buffer structure, and accuracy of experimental data is improved, so that test results are more stable and reliable.

A programming technology and a 3D printing technology are integrated in the present invention, so that an efficiency of preparing a rock-like porous medium sample can be improved by utilizing the advantages of the programming technology and the 3D printing technology, discreteness between the samples can be reduced, and the high-precision and repeatable batch customization of the rock-like porous media can be realized. It is also possible to prepare rock-like porous media meeting different requirements by quantitatively controlling the parameters such as the size of the rock sample, the distribution of internal pore size, the size of porosity and an inclination angle of joint planes, so as to improve the accuracy of quantitative study on the stress wave propagation law of the rock by pore parameters of the rock-like porous media under different test conditions.

Through the rock samples obtained by controlling the parameters of the rock sample, the high-amplitude stress wave propagation and attenuation laws can be quantitatively studied under the impact of different high-amplitude stress waves on the rock samples with the same porous characteristics, and the influence of the porous parameters on the high-amplitude stress wave propagation laws of the rock samples under the impact of different high-amplitude stress waves on the rock with different porous characteristics.

Combined with the test system of the present invention, the quantitative analysis of the rock wave propagation law test under different test conditions is realized, the blank of quantitative analysis of the change of pore medium parameters on the test study of the high-amplitude stress wave propagation law of the rock under different test conditions is filled, and great scientific study value is realized.

### BRIEF DESCRIPTION OF DRAWINGS

In order to illustrate the technical solutions in the embodiments of the present invention or in the prior art more clearly, the drawings used in the description of the embodiments or the prior art will be briefly described below. Obviously, the drawings in the following description are merely some embodiments recorded in the present invention. For those of ordinary skills in the art, other drawings may also be obtained based on these drawings without going through any creative work.

FIG. 1 is a schematic structural diagram of an embodiment of a test system of the present invention;

FIG. 2 is a schematic structural diagram of the present invention from one perspective;

FIG. 3 is a schematic structural diagram of the present invention from another perspective;

FIG. 4 is a flow chart of a test method of the present invention;

FIG. 5 is a flow chart of a method for quantitatively designing and preparing a cubic porous rock sample required by testing according to an embodiment of the present invention;

FIG. 6 is a schematic diagram of internal pore distribution in the cubic porous rock sample with randomly distributed pores according to the present invention;

FIG. 7 is a schematic diagram of internal pore distribution in the cubic porous rock sample with pores distributed in a joint plane according to the present invention;

FIG. 8 is an oscillogram of a cubic porous rock sample with randomly distributed pores with different porosities in X direction without applying a pre-stress; and

FIG. 9 is a transmitted wave spectrum diagram of the cubic porous rock sample with randomly distributed pores with different porosities in X direction without applying a pre-stress.

### REFERENCE NUMERALS

1 refer to X+ direction supporting platform, 2 refers to X+ direction confining pressure loading end baffle, 3 refers to X+ direction electromagnetic pulse excitation cavity, 4 refers to X+ direction electromagnetic pulse excitation cavity supporting frame, 5 refers to X+ direction confining pressure loading frame, 6 refers to X+ direction boss, 7 refers to X+ direction square incident bar, 8 refers to X+ direction self-lubricated square bar fixing and supporting frame, 9 refers to X+ direction linker supporting bar, 10 refers to X+ direction strain gauge, 11 refers to X+ direction square bar centering and positioning guide rail, 12 refers to X− direction supporting platform, 13 refers to X− direction confining pressure loading cylinder, 14 refers to X− direction confining pressure loading fixing end baffle, 15 refers to X− direction confining pressure loading actuator, 16 refers to X− direction linker supporting bar, 17 refers to X− direction energy absorbing and buffering device, 18 refers to X− direction square buffer bar, 19 refers to X− direction self-lubricated square buffer bar fixing and supporting frame, 20 refers to X− direction confining pressure loading frame, 21 refers to X− direction boss, 22 refers to X− direction self-lubricated square bar fixing and supporting frame, 23 refers to X− direction square transmission bar, 24 refers to X− direction strain gauge, 25 refers to X− direction beam bar centering and positioning guide rail, 26 refers to Y+ direction supporting platform, 27 refers to Y+ direction confining pressure loading end baffle, 28 refers to Y+ direction electromagnetic pulse excitation cavity, 29 refers to Y+ direction electromagnetic pulse excitation cavity supporting frame, 30 refers to Y+ direction confining pressure loading frame, 31 refers to Y+ direction boss, 32 refers to Y+ direction square incident bar, 33 refers to Y+ direction self-lubricated square bar fixing and supporting frame, 34 refers to Y+ direction linker supporting bar, 35 refers to Y+ direction strain gauge, 36 refers to Y+ direction square bar centering and positioning guide rail, 37 refers to Y− direction supporting platform, 38 refers to Y− direction confining pressure loading cylinder, 39 refers to Y− direction confining pressure loading fixing end baffle, 40 refers to Y− direction confining pressure loading actuator, 41 refers to Y− direction linker supporting bar, 42 refers to Y− direction energy absorbing and buffering device, 43 refers to Y− direction square buffer bar, 44 refers to Y− direction self-lubricated square buffer bar fixing and supporting frame, 45 refers to Y− direction confining pressure loading frame, 46 refers to Y− direction boss, 47 refers to Y− direction self-lubricated square bar fixing and supporting frame, 48 refers to Y− direction square transmission bar, 49 refers to Y− direction strain gauge, 50 refers to Y− direction beam bar centering and positioning guide rail, 51 refers to Z+ direction confining pressure loading end baffle, 52 refers to Z+ direction electromagnetic pulse excitation cavity, 53 refers to Z+ direction electromagnetic pulse excitation cavity supporting frame, 54 refers to Z+ direction boss, 55 refers to Z+ direction square incident bar, 56 refers to Z+ direction self-lubricated square bar fixing and supporting frame, 57 refers to Z+ direction vertical fixing supporting frame, 58 refers to Z+ direction strain gauge, 59 refers to Z+ direction square bar centering and positioning guide rail, 60 refers to Z− direction confining pressure loading cylinder, 61 refers to Z− direction confining pressure loading actuator, 62 refers to Z− direction confining pressure loading frame, 63 refers to Z− direction energy absorbing and buffering device, 64 refers to Z− direction self-lubricated square buffer bar fixing and supporting frame, 65 refers to Z− direction square buffer bar, 66 refers to Z− direction boss, 67 refers to Z− direction square transmission bar, 68 refers to Z− direction self-lubricated square bar fixing and supporting frame, 69 refers to Z− direction vertical fixing supporting frame, 70 refers to Z− direction strain gauge, 71 refers to Z− direction beam bar centering and positioning guide rail, 72 refers to central cubic square chest, and 73 refers to central supporting platform.

### DESCRIPTION OF EMBODIMENTS

Unless otherwise defined, all the technical and scientific terms used in the embodiments of the present invention have the same meanings as those commonly understood by those skilled in the art of the present invention. Terms used herein in the specification of the present invention are for the purpose of describing specific embodiments only and are not intended to limit the present invention. Furthermore, the terms “including” and “provided with” and any variations thereof in the specification and claims as well as the above drawings of the present invention are intended to cover non-exclusive inclusion. The terms “first”, “second” and the like in the specification and claims as well as the above drawings of the present invention are used to distinguish different objects, and are not necessarily used to describe a specific sequence.

Reference in the specification to “an embodiment” in the present invention means that a particular feature, structure, or characteristic described in connection with the embodiment may be included in at least one embodiment of the present invention. The appearances of the phrase in various places in the specification are not necessarily all referring to the same embodiment, nor are separate or alternative embodiments mutually exclusive of other embodiments. It is to be expressly and implicitly understood by those skilled in the art that the embodiments described in the present invention may be combined with other embodiments without conflict.

In order to make those skilled in the art better understand the solutions of the present invention, the technical solutions in the embodiments of the present invention will be described clearly and completely with the attached drawings.

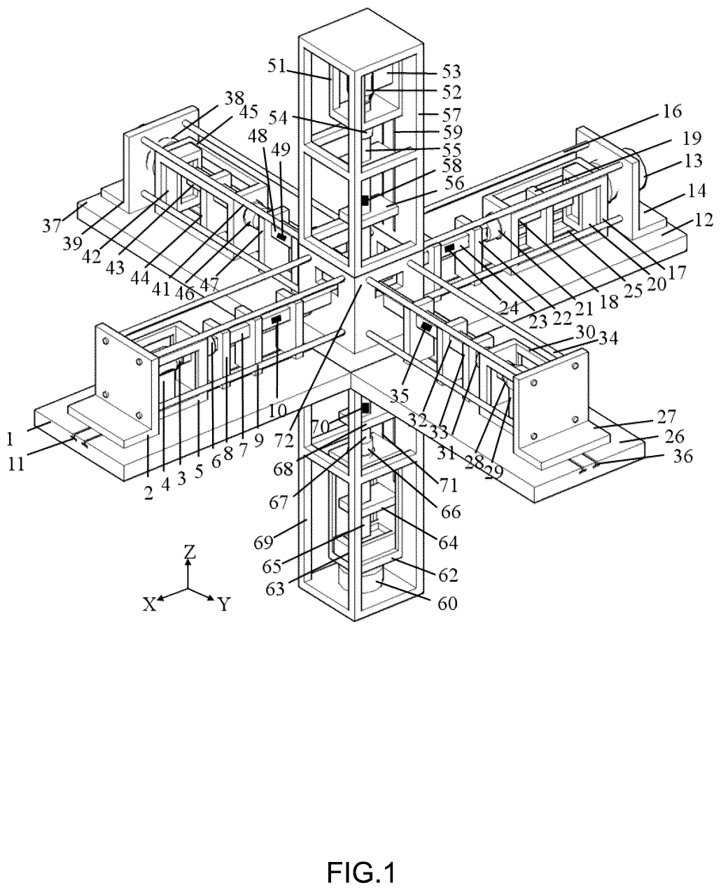

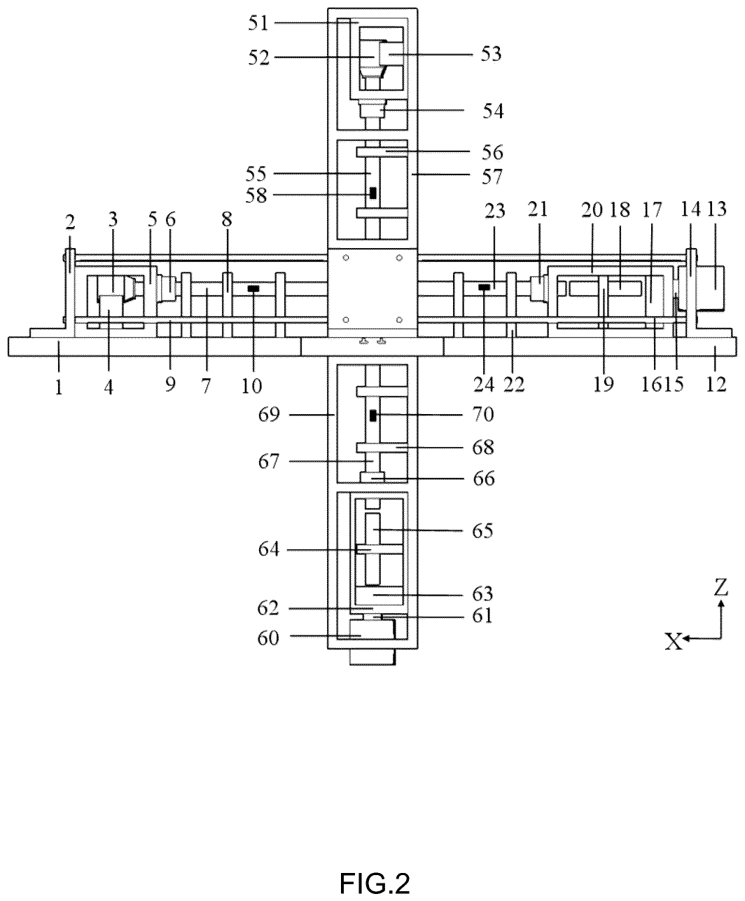

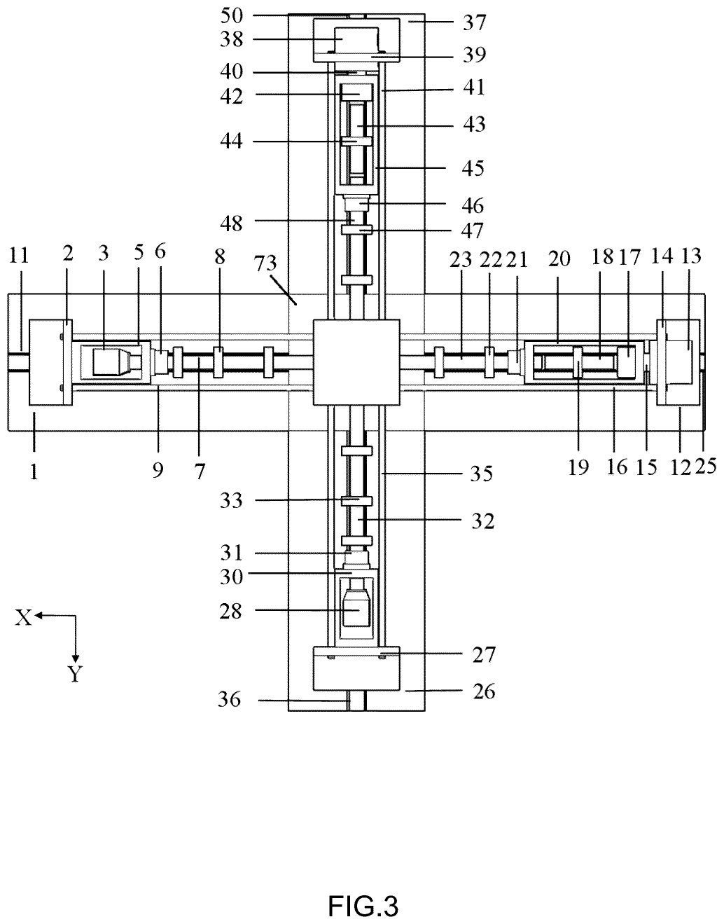

As shown in FIG. 1 to FIG. 3, the present invention adopts a dynamic true triaxial electromagnetic Hopkinson bar test system to realize three-dimensional stress wave propagation test of a true triaxial Hopkinson bar.

The dynamic true triaxial electromagnetic Hopkinson bar test system of the present invention comprises a horizontal cross supporting platform and a central cubic square chest 72 arranged in a middle part of an upper surface of the horizontal cross supporting platform, and further comprises a dynamic true triaxial electromagnetic Hopkinson bar and a test device.

The horizontal cross supporting platform comprises an X+ direction supporting platform 1, an X− direction supporting platform 12, a Y+ direction supporting platform 26, a Y− direction supporting platform 37, and a central supporting platform 73. An upper surface of the central cubic square chest 72 (along a Z+ direction) is completely open, and square openings are respectively arranged in a middle position of the central cubic square chest 72 along the X+ direction, the X− direction, the Y+ direction, the Y− direction and a Z− direction, and sizes of the square openings are the same as that of square bars. The central cubic square chest 72 is placed in a center of an upper surface of the central supporting platform 73, and forms an orthogonal coordinate system with the horizontal cross supporting platform for accurate positioning and centering of the dynamic true triaxial electromagnetic Hopkinson bar system.

Taking the central cubic square chest 72 as the center, an X+ direction square incident bar 7, an X− direction square transmission bar 23, a Y+ direction square incident bar 32, a Y− direction square incident bar 48, a Z+ direction square incident bar 55, a Z− direction square transmission bar 67, X− direction, Y− direction and Z− direction confining pressure loading systems, X+ direction, Y+ direction and Z+ direction electromagnetic pulse excitation cavities, X direction, Y direction and Z direction self-lubricated square bar fixing and supporting frames, X− direction, Y− direction and Z− direction energy absorbing and buffering systems are respectively arranged to form the dynamic true triaxial electromagnetic Hopkinson bar system.

The X+ direction square incident bar 7 is fixed by an X+ direction self-lubricated square bar fixing and supporting frame 8, and centered and connected with the central cubic square chest 72 in an X+ direction square opening along an X+ direction square incident bar centering and positioning guide rail 11. An X+ direction electromagnetic pulse excitation cavity 3 and an X+ direction electromagnetic pulse excitation cavity supporting frame 4 are placed in an X+ direction confining pressure loading frame 5, and placed at an incident end of the X+ direction square incident bar 7 and is closely attached to the incident end of the X+ direction square incident bar 7. The X+ direction confining pressure loading frame 5 is connected with an X+ direction boss 6 in series, and used for applying an X+ direction static confining pressure and a dynamic stress impulse load on a sample for testing along the incident end of the X+ direction square incident bar 7. An X+ direction strain gauge 10 is attached to the X+ direction square incident bar 7 for collecting incident wave signals and reflected wave signals on the X+ direction square incident bar 7. An X+ direction linker supporting bar 9 connects an X+ direction confining pressure loading baffle 2 with the central cubic square chest 72 to provide a fixing frame and a counter-force supporting system for applying an X+ direction static confining pressure. An X− direction confining pressure loading cylinder 13 and an X− direction confining pressure loading actuator 15 are connected and combined with an X− direction confining pressure loading frame 20 in series. The X− direction confining pressure loading frame 20 and an X− direction boss 21 are connected in series and used for applying an X− direction static confining pressure to the sample for testing along the X− direction. An X− direction linker supporting bar 16 connects an X− direction confining pressure loading fixing end baffle 14 and the central cubic square chest 72 to provide a fixing frame and a counter-force supporting system for applying an X− direction static confining pressure.

The X− direction square transmission bar 23 is fixed by an X− direction self-lubricated square bar fixing and supporting frame 22, and centered and connected with the central cubic square chest 72 in an X− direction square opening along an X− direction square bar centering and positioning guide rail 25. An X− direction strain gauge 24 is attached to the X− direction square transmission bar 23 for collecting transmitted wave signals on the X− direction square transmission bar 23. An X− direction square buffer bar 18, an X− direction self-lubricated square buffer bar fixing and supporting frame 19 and an X− direction energy absorbing and buffering device 17 are placed in the X− direction confining pressure loading frame 20. The X− direction square buffer bar 18 is fixed by the X− direction self-lubricated square buffer bar fixing and supporting frame 19 and accurately centered with the X− direction square transmission bar 23 along the X− direction beam bar centering and positioning guide rail 25. The X− direction energy absorbing and buffering device 17 is placed right behind the X− direction square buffer bar 18 and used for absorbing residual energy in the X direction.

The Y+ direction square incident bar 32 is fixed by a Y+ direction self-lubricated square bar fixing and supporting frame 33, and centered and connected with the central cubic square chest 72 in a Y+ direction square opening along a Y+ direction square bar centering and positioning guide rail 36. A Y+ direction electromagnetic pulse excitation cavity 28 and a Y+ direction electromagnetic pulse excitation cavity supporting frame 29 are placed in a Y+ direction confining pressure loading frame 30, and placed in an incident end of the Y+ direction square incident bar 32 and tightly attached to the incident end of the Y+ direction square incident bar 32. The Y+ direction confining pressure loading frame 30 is connected with a Y+ direction boss 31 in series, and used for applying a Y+ direction static confining pressure and a dynamic stress impulse load to the sample for testing along the incident end of the Y+ direction square incident bar 32. A Y+ direction strain gauge 35 is attached to the Y+ direction square incident bar 32 for collecting incident wave signals and reflected wave signals on the Y+ direction square incident bar 32. A Y+ direction linker supporting bar 34 connects a Y+ direction confining pressure loading baffle 2 with the central cubic square chest 72 to provide a fixing frame and a counter-force supporting system for applying a Y+ direction static confining pressure. A Y− direction confining pressure loading cylinder 38 and a Y− direction confining pressure loading actuator 40 are connected and combined with a Y− direction confining pressure loading frame 45 in series. The Y− direction confining pressure loading frame 45 and a Y− direction boss 46re connected in series and used for applying a Y− direction static confining pressure to the sample for testing along the Y− direction. A Y− direction linker supporting bar 41 connects a Y− direction confining pressure loading fixing end baffle 39 and the central cubic square chest 72 to provide a fixing frame and a counter-force supporting system for applying a Y− direction static confining pressure.

The Y− direction square incident bar 48 is fixed by a Y− direction self-lubricated square bar fixing and supporting frame 47, and centered and connected with the central cubic square chest 72 in a Y− direction square opening along a Y− direction beam bar centering and positioning guide rail 50. A Y− direction strain gauge 49 is attached to the Y− direction square incident bar 48 for collecting transmitted wave signals on the Y− direction square incident bar 48. The Y− direction square buffer bar 43, a Y− direction self-lubricated square buffer bar fixing and supporting frame 44 and a Y− direction energy absorbing and buffering device 42 are placed in the Y− direction confining pressure loading frame 45. The Y− direction square buffer bar 43 is fixed by the Y− direction self-lubricated square buffer bar fixing and supporting frame 44 and is accurately centered with the Y− direction square incident bar along the Y− direction beam bar centering and positioning guide rail 50. The Y− direction energy absorbing and buffering device 42 is placed right behind the Y− direction square buffer bar 43 and used for absorbing residual energy in the Y direction.

The Z+ direction square incident bar 55 is fixed by a Z+ direction self-lubricated square bar fixing and supporting frame 56, and centered and connected with the central cubic square chest 72 in a Z+ direction square opening along a Z+ direction square bar centering and positioning guide rail 59. A Z+ direction electromagnetic pulse excitation cavity 52 and a Z+ direction electromagnetic pulse excitation cavity supporting frame 53 are placed in a Z+ direction confining pressure loading frame 51 and placed in an incident end of the Z+ direction square incident bar 55 and is freely and tightly attached with the incident end of the Z+ direction square incident bar 55. The Z+ direction confining pressure loading frame 51 and a Z+ direction boss 54 are connected in series, and used for applying a Z+ direction static confining pressure and a dynamic stress impulse load along the incident end of the Z+ direction square incident bar 55. A Z+ direction strain gauge 58 is attached to the Z+ direction square incident bar 55 for collecting incident wave signals and reflected wave signals on the Z+ direction square incident bar 55. A Z+ direction vertical fixing supporting frame 57 is connected with the central cubic square chest 72 to provide a fixing frame and a counter-force supporting system for applying a Z+ direction static confining pressure. A Z− direction confining pressure loading cylinder 60 and a Z− direction confining pressure loading actuator 61 are connected and combined with a Z− direction confining pressure loading frame 62 in series. The Z− direction confining pressure loading frame 62 and a Z− direction boss 66 are connected in series and used for applying a Z− direction static confining pressure to the sample for testing along the Z− direction. A Z− direction vertical fixing supporting frame 69 is connected with the central cubic square chest 72 to provide a fixing frame and a counter-force supporting system for applying a Z− direction static confining pressure.

The Z− direction square transmission bar 67 is fixed by a Z− direction self-lubricated square bar fixing and supporting frame 68, and centered and connected with the central cubic square chest 72 in a Z− direction square opening along a Z− direction square beam bar centering and positioning guide rail 71. A Z− direction strain gauge 70 is attached to the Z− direction square transmission bar 67 for collecting transmitted wave signals on the Z− direction square transmission bar 67. The Z− direction square buffer bar 65, a Z− direction self-lubricated square buffer bar fixing and supporting frame 64 and a Z− direction energy absorbing and buffering device 63 are placed in the Z− direction confining pressure loading frame 62. The Z− direction square buffer bar is fixed by the Z− direction self-lubricated square buffer bar fixing 65 and supporting frame 64 and accurately centered with the Z− direction square transmission bar 67 along a Z− direction beam bar centering and positioning guide rail 71. The Z− direction energy absorbing and buffering device 63 is placed right behind the Z− direction square buffer bar 65 and used for absorbing residual energy in the Z direction.

It should be noted that the X+ direction static confining pressure and the X− direction static confining pressure are in a relation of an acting force and a reacting force which have equal magnitude and opposite directions, the Y+ direction static confining pressure and the Y− direction static confining pressure are in a relation of an acting force and a reacting force which have equal magnitude and opposite directions, while the Z+ direction static confining pressure and the Z− direction static confining pressure are in a relation of an acting force and a reacting force which have equal magnitude and opposite directions.

In this embodiment, the stress measuring element can not only be a stress sheet through which an external analytical instrument can receive signals, but also be other strain sensors.

The rocks in nature are not only anisotropic, but also unrepeatable. Meanwhile, most of the existing studies on stress wave propagation in porous rocks use Hopkinson bar to carry out one-dimensional stress wave propagation test and pseudo-triaxial test. Combining the above two points, the existing problems of the stress wave propagation in the porous rocks are mainly reflected in the difficulty of carrying out high-precision quantitative study on the three-dimensional high-amplitude stress wave propagation law of the rocks, which restricts the further study of anisotropic properties of the porous rocks. The dynamic true triaxial electromagnetic Hopkinson bar test system is used to carry out the three-dimensional high-amplitude stress wave propagation test of the samples prepared above, which can make up for the shortcomings of the existing study. On the basis of triaxial synchronous coordinated control of the electromagnetic loaded Hopkinson bar system, the stress wave signals of the incident bars and the transmission bars in X, Y and Z directions are recorded during the two processes of applying true triaxial static pre-stress (confining pressure) and impact load respectively, and then the high-amplitude stress wave propagation and attenuation laws in the porous rocks in multiple dimensions are analyzed by using the stress wave signals.

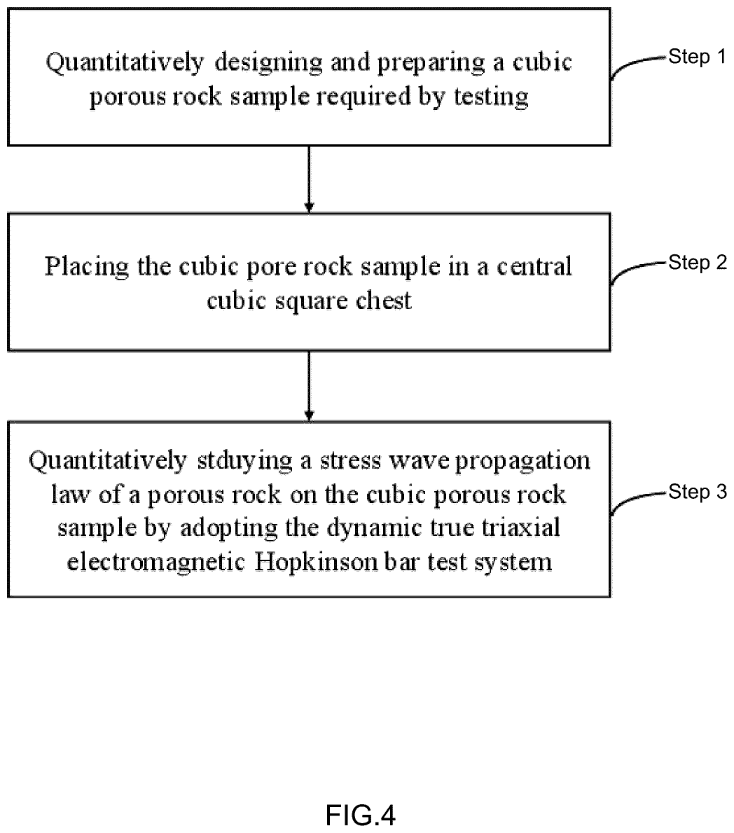

As shown in FIG. 4, the present invention adopts a dynamic true triaxial electromagnetic Hopkinson bar test system to realize a test method for quantitatively studying a stress wave propagation law of a porous rock, which comprises the following step:
step 1: quantitatively designing and preparing a cubic porous rock sample required by testing.

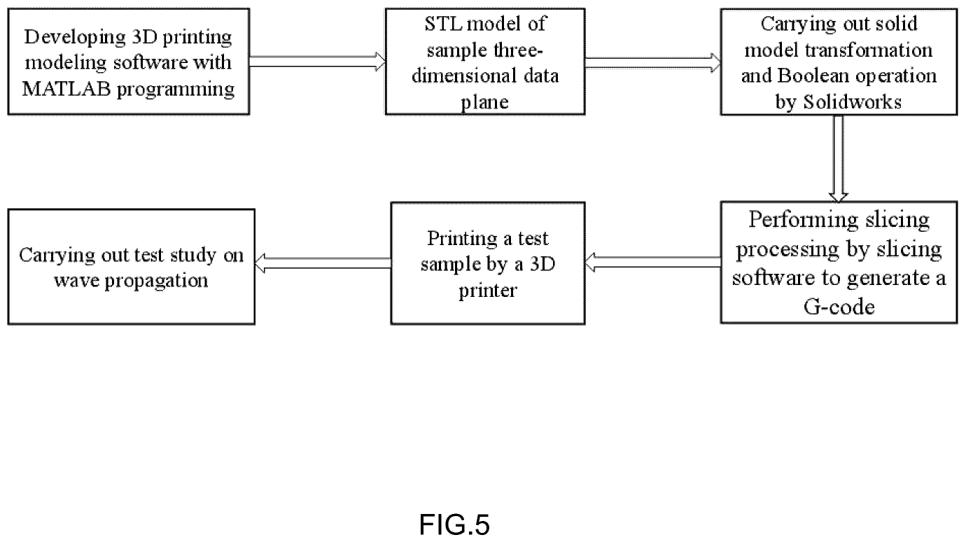

As shown in FIG. 5, a programming technology and a 3D printing technology are integrated in the present invention, so that an efficiency of preparing a rock-like porous medium sample can be improved by utilizing the advantages of the programming technology and the 3D printing technology, discreteness between the samples can be reduced, and the high-precision and repeatable batch customization of the rock-like porous media can be realized. It is also possible to prepare rock-like porous media meeting different requirements by quantitatively controlling the parameters such as the size of the rock sample, the distribution of internal pore size, the size of porosity and an inclination angle of joint planes, so as to improve the accuracy of quantitative study on the stress wave propagation law of the rock by pore parameters of the rock-like porous media under different test conditions.

As the optimal embodiment of the present invention, the step of quantitatively designing and preparing the cubic porous rock sample required by testing in this embodiment comprises the following steps:
step 101: establishing a sample three-dimensional model data plane: establishing a cubic three-dimensional model with arbitrary spatial distribution of pores with a set shape based on MATLAB programming, and acquiring a file containing sample three-dimensional model data plane information;
step 102: converting the three-dimensional data model plane into a three-dimensional solid: converting the sample three-dimensional model data plane of the file into the three-dimensional solid, and processing the three-dimensional solid to obtain a qualified sample three-dimensional solid model containing pores; and
step 103: performing slicing and 3D printing processing of the model: slicing the processed file of the sample three-dimensional solid model, setting a non-porous medium part in the sample to be cured and a porous medium part to be non-cured, acquiring a code file which is recognized by a 3D printer, and then inputting the code file to the 3D printer for 3D printing, and finally obtaining the cubic porous medium sample for experimental testing.

In the step 101, the sample three-dimensional model data plane is established.

In this embodiment, the MATLAB programming tool is preset with a series of parameters for controlling the rock sample, and through the setting of the parameters, the corresponding STL format file of the sample three-dimensional model data plane is obtained to realize accurate quantitative control of the porous medium characteristic of the cubic porous rock sample, wherein the parameters comprise a porosity, a pore size range, and spatial distribution of pores of the rock sample.

Preferably, the shape of the pore in this embodiment is spherical. Of course, according to actual demands of the test, the shape of the pore of the rock sample may be adjusted to other shapes as required, such as a coin shape, an ellipsoid shape, a polyhedron or irregular polyhedron shape, an irregular body shape, or the like.

A method for generating the sample three-dimensional model data plane comprises the following steps:
A1: starting, acquiring a pore distribution mode, and then acquiring the input parameters for controlling the rock sample;
A2: generating three-dimensional data of the rock sample with corresponding shape and size;
A3: generating corresponding spherical pore spherical data according to the input parameters;
A4: calculating a porosity, determining whether the porosity is within a set interval, if yes, deriving porous data and then executing step A5, if not, returning to executing step A3; and
A5: exporting the porous data, and writing the three-dimensional data of the rock sample and the porous data into an STL format file, and ending.

As a first embodiment of the present invention, the sample three-dimensional model data plane in this embodiment adopts randomly distributed pores, and a method for generating the sample three-dimensional model data plane with randomly distributed pores comprises the following steps.

In A110, the parameters for controlling the rock sample input by a user are acquired, wherein the parameters comprise a cube size parameter, and spherical pore size range, number and porosity parameters of the rock sample.

The user may set a length of the rock sample, a width of the rock sample, a height of the rock sample, an upper radius limit of the pore, a lower radius limit of the pore, a number of pores and a porosity in the software interface. After relevant parameters are entered according to the test requirements, a conform button is clicked to start to run the generation.

In A111, a volume is calculated according to the size parameter of the rock sample and corresponding three-dimensional data of the sample model are generated.

In this embodiment, the MATLAB programming tool may establish a formula for calculating the volume of the cube and a relevant code for constructing a three-dimensional data plane of the cube. This step can calculate the volume of the cylinder according to the size parameters input by the user and generate the three-dimensional data of the cubic porous rock sample model.

In A112, porous data of globules with specified number and distribution globular porous data are generated internally by analogy based on a function that radius distribution of spherical pores is Gaussian distribution.

The function that the radius distribution of spherical pores is Gaussian distribution is established, and a cycle is established at the same time. In the cycle, XYZ coordinates of one spherical pore inside the cube corresponding to the radius of the spherical pore are generated in turn every time according to the coordinate parameters of the cube. When the generated spherical pore data are greater than 2, it is determined whether the pores overlap. If it is determined that the pores overlap, globules coordinates of the latest cycle are re-generated until the globules do not overlap with each other. After determining that the requirements are met, next cycle is carried out to generate the porous data of globules with specified number and distribution globular porous data internally by analogy.

In A113, a volume of the globules is calculated according to a formula for calculating the volume of the globules, the volume of the globules is divided by the volume of the cube to obtain the porosity, and it is determined whether the porosity is within an error interval, if so, step A114 is executed, and if not, step A112 is re-executed.

In this embodiment, the MATLAB programming tool calculates the volume of the globules according to the radius data of the globules stored in the matrix and the formula for calculating the volume of the globules, and then divides the volume of the globules by the volume of the cube to obtain one porosity, and meanwhile, establishes an error interval of the porosity.

It is determined whether the porosity is within the error interval. If the porosity is within the error interval, next step is executed. If the porosity is not within the error interval, a new cycle is started, wherein a number of cycles is set. Within the specified number of cycles, step A112 and step A113 will be repeatedly executed to realize the functions of re-generating the data of the globules and calculating the porosity.

If the data of the globules that meet the porosity error is generated within the specified number of cycles, next step will be executed. If the data of the globules that meet the porosity error is not generated, the program will prompt the user to re-input the control parameters and return to step A110 to re-generate the sample model.

In A114, qualified porous data and cube data are output in TXT file format and xlsx file format.

In A115, according to XYZ coordinate values of the globules, spherical data are established at the position, and the cube data and the data of the globules are written into one STL format file.

As a second embodiment of the present invention, the sample three-dimensional model data plane adopts pores distributed in a joint plane, and a method for generating the sample three-dimensional model data plane with pores distributed in a joint plane comprises the following steps.

In A120, the parameters for controlling the rock sample input by a user are acquired, wherein the parameters a cube size parameter, spherical pore size range, number, porosity, distance of globules in XYZ coordinates and distance of the whole joint surface in Z coordinate of the rock sample.

The user may set a length of the rock sample, a width of the rock sample, a height of the rock sample, an upper radius limit of the pore, a lower radius limit of the pore, dx, dy, dz, dz1 and a porosity in the software interface. In a lower right corner of the software interface, a prompt card for the four parameters of dx, dy, dz and dz1 is provided, wherein dx represents spacing of a single joint in an X-axis direction of a spatial coordinate; dy represents spacing of a single pore in a Y-axis direction of the spatial coordinate; dz represents spacing of a single pore in a z-axis direction of the spatial coordinate; and dz1 represents a distance between joint planes in the Z-axis direction of the spatial coordinate. After relevant parameters are entered according to the test requirements, a conform button is clicked to start to run the generation.

In A121, a coordinate of an initial spherical pore and random one radius value within a determined radius range are generated, and an empty txt file is created at the same time to record the coordinate of the initial pore and radius data.

In A122, a volume is calculated according to the cube size parameter of the rock sample and the corresponding three-dimensional data of the sample model is generated.

In this embodiment, the MATLAB programming tool will establish a formula for calculating the volume of the cube and a relevant code for constructing a three-dimensional data plane of the cube, and write the data into the txt file. This step can calculate the volume of the cube according to the size parameters of the cube input by the user and generate the three-dimensional data for recording the cubic porous rock sample model.

In A123, a single joint, a single joint plane and a plurality of joint planes are sequentially generated with an initial globule as a center, and then the coordinate and the radius data are stored in the file in turn.

In this embodiment, a cycle of generating the single joint, the single joint plane and the plurality of joint planes with the initial globule as the center is established in turn. First, starting from the initial globule, the single joint is generated by cyclically changing a YZ distance of a midpoint of the pore of the globule in space, then the whole joint plane is generated by changing an X coordinate of the whole joint, and finally the plurality of joint planes in the cubic porous rock sample are generated by changing a Z coordinate of the joint plane. Finally, the coordinate and radius data are stored in the txt file in turn.

In A124, the data in the file are returned to one matrix, a volume of the globules is calculated according to the radius data of the globules stored in the matrix, the volume of the globules is divided by the volume of the cube to obtain the porosity, and it is determined whether the porosity is within the error interval, if so, step A125 is executed, and if not, steps A121, A123 and A124 are re-executed in turn to re-generate the data of the globules and calculate the porosity according to a set number of cycles and within a specified number of cycles.

If the data of the globules that meet the porosity error is generated within the specified number of cycles, next step will be executed. If the data of the globules that meet the porosity error is not generated, the program will prompt the user to re-input the control parameters and return to step A120 to re-generate the sample model.

In A125, the qualified porous data and cube data are outputted in an xlsx file format for subsequent data processing.

In A126, according to XYZ coordinate values of the globules, spherical data are established at the position, and then two cycles are carried out in turn to write the cube data and the data of the globules into one STL format file.

In the step 102, the three-dimensional data plane is converted into the three-dimensional solid.

In the step 102, the output STL format file is processed by Solidworks software, the STL format file is imported into Solidworks in the form of a solid, the three-dimensional data plane of the file is converted into the three-dimensional solid, and then a cube solid and a globule solid are subjected to Boolean subtraction operation to obtain the qualified sample three-dimensional solid model containing pores.

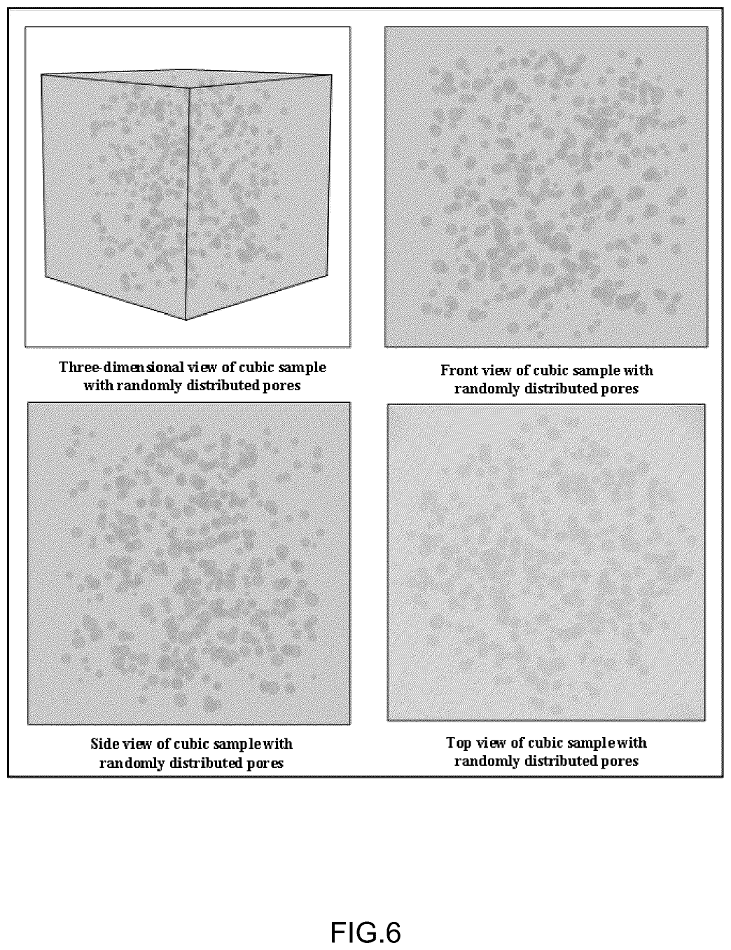

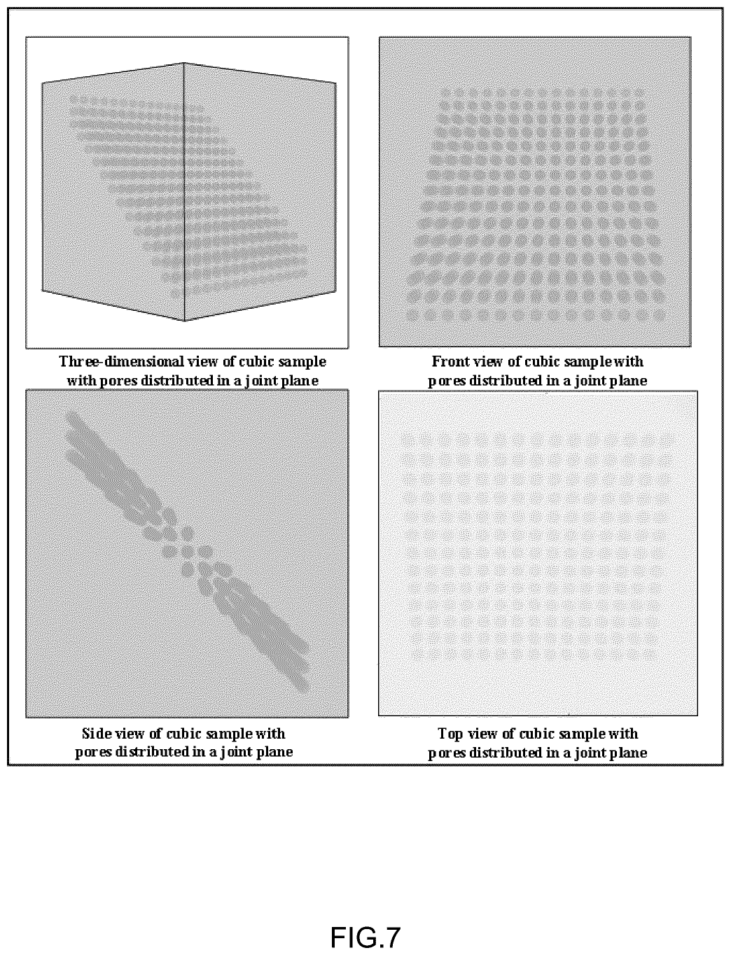

The rock sample generated by the first embodiment of the present invention and the internal pore distribution are shown in FIG. 6. The rock sample generated by the second embodiment of the present invention and the internal pore distribution is shown in FIG. 7.

In step 103, slicing and 3D printing are carried out on the model.

Further, in the step 103, the STL format file processed in the step 102 is imported into slicing software for the slicing process of 3D printing, in the slicing process, a G-code recognized by the 3D printer is created, and finally, the 3D printer performs printing operation according to the sliced file, and finally the rock sample for testing is manufactured.

Specifically, this embodiment imports the processed STL format file into the slicing software, sets relevant parameters for the slicing software, such as a printer type and parameters, selects a 3D printer model to be used, and sets relevant parameters, such as a printing speed and a layer height. For material selection, printing materials to be used are specified, such as PLA, ABS, PETG, or the like. For a supporting structure, it is determined whether a supporting structure is needed to support a suspended or cantilever part. For a filling density, a filling density inside the model is selected, which is usually expressed in a way of percentage ratio. For temperature setting, temperatures of a printing head and a heating bed are set. For layer resolution, a thickness of each printed layer is determined, which is usually expressed in millimeters. For a printing speed, a moving speed of the printing head is adjusted to affect the printing speed and quality. For support and attachment, parameters of support and base are configured to ensure that the model adheres to a printing base. For path planning, a movement path of the printing head is set to minimize printing time and reduce vibration during the movement. For other advanced options, other specific settings are performed as needed, such as printing sequence, automatic stop, or the like. Slicing is carried out after setting, and previewing is performed after slicing to make sure that the slicing is layered correctly, and then a slicing file, which is a G-code file is exported after confirmation. The file contains instructions executed by the printer. The generated G-code is transmitted to the printer, and the printing task is started. During the printing process, the operation of the printer is monitored in real time. After the printing is completed, the test samples are taken out and necessary post-processing is carried out, such as cleaning the surface and removing the support.

The method for quantitatively designing and preparing of the present invention comprises the overall process from programming and modeling to outputting the original STL format file, then processing the STL format file, and finally printing the product. According to the method for quantitatively designing and preparing of the present invention, not only can the advantages of programming and 3D printing technology be utilized to improve the sample preparation efficiency and reduce the discreteness between the samples, but also parameters such as the sample size, the internal pore size distribution, the porosity and the inclination angle of the joint planes of the rock samples can be quantitatively controlled. By controlling the parameters of the rock samples, the characteristics of the rocks with different porosity under different high-amplitude stress waves are studied.

In step 2, the cubic pore rock sample is placed in the central cubic square chest, wherein the central cubic square chest and the horizontal cross supporting platform form an orthogonal coordinate system for accurately positioning and centering the dynamic true triaxial electromagnetic Hopkinson bar and six surfaces of the cubic porous rock sample.

In step 3, a stress wave propagation law of the porous rock is quantitatively studied on the cubic porous rock sample by adopting the dynamic true triaxial electromagnetic Hopkinson bar test system.

A specific implementation method of the embodiment is as follows.

In step 301, a high-amplitude dynamic stress wave is applied under the condition of not applying a static pre-stress.

An X+ direction electromagnetic pulse excitation cavity 3 and an X+ direction electromagnetic pulse excitation cavity supporting frame 4 are placed in an X+ direction confining pressure loading frame 5, and placed at an incident end of an X+ direction square incident bar 7 to ensure that the X+ direction electromagnetic pulse excitation cavity 3 is closely attached to the incident end of the square incident bar 7, and make the X+ direction square incident bar 7 and an X− direction square transmission bar 23 be closely attached to the sample near the cubic porous rock sample side.

A high-amplitude dynamic stress wave is applied to the sample for testing at the incident end of the X+ direction square incident bar 7, wherein the dynamic stress wave is transmitted to the X+ direction square incident bar 7 as an X+ direction stress wave via a left end face of the X+ direction square incident bar 7, and then the X+ direction stress wave is propagated from the X+ direction to the X− direction to the cubic porous rock sample along an axis direction of the X+ direction square incident bar 7 and propagated to the X− direction square transmission bar 23 as an X− direction transmitted stress wave; after receiving the X− direction transmitted stress wave, the X− direction square transmission bar 23 moves backward and hits an X− direction square buffer bar 18, and transfers energy to the X− direction square buffer bar 18 at the same time; the X− direction square buffer bar 18 moves backward and hits an X− direction energy absorbing and buffering device 17 therebehind, and the X− direction energy absorbing and buffering device 17 absorbs all the energy to prevent the X− direction square buffer bar 18 from moving in an opposite direction and hitting the X− direction square transmission bar 23, thus completing one complete X direction loading.

An X+ direction strain gauge 10 and an X− direction strain gauge 24 may be used to record and save complete stress wave signal data in the X direction after applying the dynamic impact load under the condition of not applying a static pre-stress, comprising incident stress wave signals, reflected stress wave signals and transmitted stress wave signals.

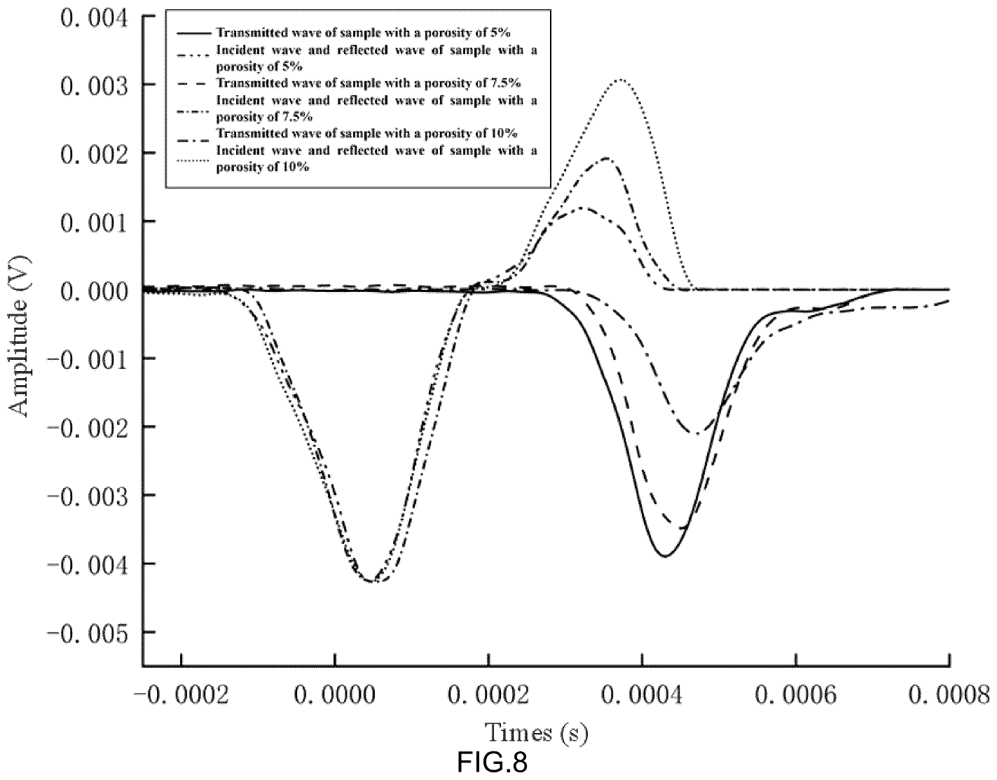

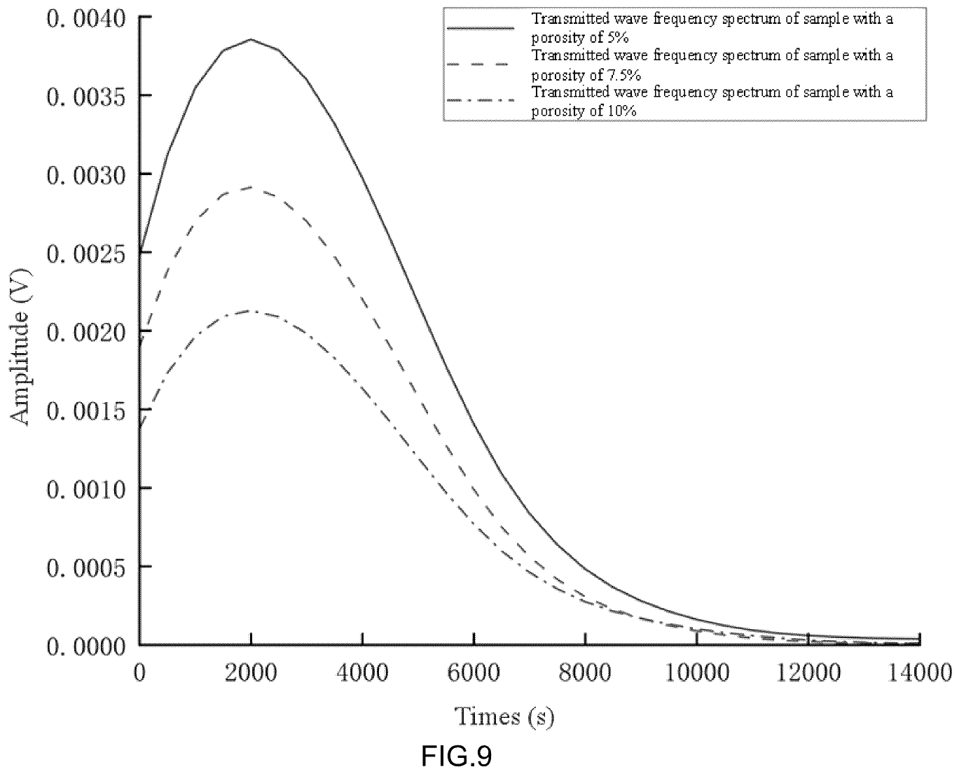

Similarly, same operations are carried out on Y and Z directions to use the dynamic true triaxial electromagnetic Hopkinson bar system to apply a dynamic impact load on the sample for testing, and record and save complete stress wave signal data in the X, Y and Z directions after applying the dynamic impact load under the condition of not applying a static pre-stress. The recorded stress wave data are analyzed, and a reflection coefficient of each impact in three directions is calculated according to a formula

$$R = \frac{{A}_{r}}{{A}_{0}} ,$$

wherein A₀ is an amplitude of an incident wave signal, and Aᵣ is an amplitude of a reflected wave signal; a transmission coefficient of each impact in three directions is calculated according to a formula

$$T = \frac{{A}_{t}}{{A}_{0}} ,$$

wherein Aₜ is an amplitude of a transmitted wave signal; meanwhile, the transmitted wave signals in three directions are respectively imported into Python or MATLAB software for frequency analysis. Firstly, the signals are normalized, a window function after normalization is selected according to signal characteristics, then the data are subjected to windowing, and fast Fourier transform (FFT) is carried out on the data after windowing to convert the data in original time domain of the transmitted signals into data in frequency domain, and data of positive axis is intercepted for drawing. In this way, distribution and change laws of transmitted wave energy in frequency range are understood. The following is the test result taking the X-axis as an example. As shown in FIG. 8, the reflection coefficients and transmission coefficients of rock samples with three porosities in the X-axis direction are calculated by using a formula to obtain that the sample with a porosity of 5% has a reflection coefficient of 0.28 and a transmission coefficient of 0.92; the sample with a porosity of 7.5% has a reflection coefficient of 0.46 and a transmission coefficient of 0.82; and the sample with a porosity of 5% has a reflection coefficient of 0.72 and a transmission coefficient of 0.49. It can be found that the porosity ranges from 5% to 7.5% and then to 10%. The reflection coefficient shows an increasing trend, and the percentages increased are 37.6% and 37.8% respectively. However, the transmission coefficient shows a decreasing trend, and the percentages decreased are 10.5% and 39.8% respectively. As shown in FIG. 9, it can be seen that on the X-axis, the porosity ranges from 5% to 7.5% and then to 10%, and an amplitude in a frequency domain shows a decreasing trend, with specific values of 25% and 26% respectively. By analyzing the reflection coefficient, the transmission coefficient and the frequency spectrum of the sample, change laws of the reflection coefficient, the transmission coefficient and the frequency spectrum of the sample under the condition of not applying a pre-stress can be obtained, so as to quantitatively analyze high-amplitude stress wave propagation and attenuation laws of the sample under the condition of not applying a pre-stress.

In step 302, a static pre-stress is applied.

Taking the X direction as an example, a way to apply the static pre-stress is given: opening a high-pressure oil pipe, charging oil into an X− direction confining pressure loading cylinder 13 through an oil inlet, and pushing an X− direction confining pressure loading actuator 15 to move forward and contact with an X− direction confining pressure loading frame 20; and continuously applying an oil pressure to push the X− direction confining pressure loading actuator 15 to move forward, transferring an axial pressure to the X− direction square transmission bar 23 through an X− direction second boss 21, and then acting on the cubic porous rock sample, so that the cubic porous rock sample is statically pre-stressed in the X direction, similarly, static confining pressure loading principles in the Y and Z directions being the same as that in the X direction.

It should be noted that through a static confining pressure loading servo controller system, synchronous control loading of static pre-stress in the X, Y and Z directions can be realized, and respective load amplitudes of the static pre-stress in the X, Y and Z directions can be flexibly set according to the needs of experimental testing.

In step 303, a high-amplitude dynamic stress wave is applied under the condition of applying a static pre-stress.

The X+ direction electromagnetic pulse excitation cavity 3 and the X+ direction electromagnetic pulse excitation cavity supporting frame 4 are placed in the X+ direction confining pressure loading frame 5, and placed at the incident end of the X+ direction square incident bar 7 to ensure that the X+ direction electromagnetic pulse excitation cavity 3 is closely attached to the incident end of the square incident bar 7, and make the X+ direction square incident bar 7 and the X− direction square transmission bar 23 be closely attached to the sample near the cubic porous rock sample side.

The high-amplitude dynamic stress wave is applied on the sample for testing along the incident end of the X+ direction square incident bar 7, wherein the dynamic stress wave is transmitted to the X+ direction square incident bar 7 as an X+ direction stress wave via a left end face of the X+ direction square incident bar 7, and then the X+ direction stress wave is propagated from the X+ direction to the X− direction to the cubic porous rock sample along an axis direction of the X+ direction square incident bar 7 and propagated to the X− direction square transmission bar 23 as an X− direction transmitted stress wave; after receiving the X− direction transmitted stress wave, the X− direction square transmission bar 23 moves backward and hits the X− direction square buffer bar 18, and transfers energy to the X− direction square buffer bar 18 at the same time; the X− direction square buffer bar 18 moves backward and hits an X− direction energy absorbing and buffering device 17 therebehind, and the X− direction energy absorbing and buffering device 17 absorbs all the energy to prevent the X− direction square buffer bar 18 from moving in an opposite direction and hitting the X− direction square transmission bar 23, thus completing one complete X direction loading.

The X+ direction strain gauge 10 and the X− direction strain gauge 24 may be used to record and save complete stress wave signal data in the X direction after applying the dynamic impact load under the condition of applying a static pre-stress, comprising incident stress wave signals, reflected stress wave signals and transmitted stress wave signals.

Similarly, same operations are carried out on Y and Z directions to use the dynamic true triaxial electromagnetic Hopkinson bar system to apply a dynamic impact load on the sample for testing, and record and save complete stress wave signal data in the X, Y and Z directions after applying the dynamic impact load under the condition of applying a static pre-stress. By analyzing the complete stress wave data in the X, Y and Z directions with the same method as that without applying a pre-stress, change laws of the reflection coefficient, the transmission coefficient and the frequency spectrum of the sample under the condition of applying a pre-stress can be obtained, so as to quantitatively analyze multi-directional high-amplitude stress wave propagation and attenuation laws of the sample under the condition of applying a pre-stress.

In step 304, an amplitude of the dynamic stress wave and/or the static pre-stress is adjusted respectively.

The amplitude of the dynamic stress wave and/or the static pre-stress is adjusted respectively, and the steps 301 to 303 are executed respectively, then different high-amplitude dynamic stress wave propagation and attenuation laws in a certain cubic porous rock sample are analyzed based on the complete stress wave signal data in the X, Y and Z directions acquired under the conditions of not applying a static pre-stress and applying a static pre-stress more than once.

In step 305, Different cubic porous rock samples are switched to perform multi-dimensional test.

Different cubic porous rock samples are switched and the steps 301-304 are re-executed to analyze the high-amplitude stress wave propagation and attenuation laws of a plurality of porous rocks in multiple dimensions by using a plurality of groups of stress wave signals.

It can be known via the above solutions that, through the rock samples obtained by controlling the parameters of the rock sample, the high-amplitude stress wave propagation and attenuation laws can be studied under the impact of different stress waves on the rock samples with the same porous characteristics, and the influence of the porous parameters on the high-amplitude stress wave propagation and attenuation laws of the rock samples under the impact of different high-amplitude stress waves on the rock with different porous characteristics.

The dynamic true triaxial electromagnetic Hopkinson bar stress wave test system realizes multi-dimensional quantitative studying on the high-amplitude stress wave propagation and attenuation laws in the rock sample for the first time, improves the precision of quantitative studying on the high-amplitude stress wave propagation and attenuation laws in this field, fills in the blank of quantitative analysis of the change of pore medium parameters on the test study of the high-amplitude stress wave propagation law of the rock under different test conditions, and has great scientific study value.

The specific embodiments described above are the preferred embodiments of the present invention, and is not intended to limit the specific implementation scope of the present invention. The scope of the present invention includes but is not limited to the specific embodiments, and all equivalent changes made according to the present invention are within the protection scope of the present invention.

What is claimed is:

1. A test method for quantitatively studying a stress wave propagation law of a porous rock, comprising: adopting a dynamic true triaxial electromagnetic Hopkinson bar test system for testing, wherein the dynamic true triaxial electromagnetic Hopkinson bar test system comprises a horizontal cross supporting platform, and a central cubic square chest arranged in a middle part of an upper surface of the horizontal cross supporting platform, and further comprises a dynamic true triaxial electromagnetic Hopkinson bar and a test device;
X₊ direction, Y₊ direction and Z₊ direction square bars of the dynamic true triaxial electromagnetic Hopkinson bar are square incident bars, X₋ direction, Y₋ direction and Z₋ direction square bars are square transmission bars, one sides of the X₊ direction, Y₊ direction and Z₊ direction square bars near an incident stress wave loading end are each provided with one first boss, rear ends of the X₋ direction, Y₋ direction and Z₋ direction square bars away from the X₊ direction, Y₊ direction and Z₊ direction square bars are each provided with one second boss, and rear ends of the second bosses are each provided with one square buffer bar with a cross-section size same as that of X direction, Y direction and Z direction square transmission bars to realize centration with the square bar in the same direction, an X₋ direction square buffer bar, a Y₋ direction square buffer bar and a Z₋ direction square buffer bar are respectively fixed by square buffer bar fixing and supporting frames, a rear side of the square buffer bar is further provided with one energy absorbing and buffering device for absorbing energy transferred by the buffer bar;
the square incident bars in the X₊ direction, the Y₊ direction and the Z₊ direction and the square transmission bars in the X₋ direction, the Y₋ direction and the Z₋ direction of the dynamic true triaxial electromagnetic Hopkinson bar are respectively fixed on the horizontal cross supporting platform by the square bar fixing and supporting frames, and the square incident bars and the square transmission bars are centered and connected with the central cubic square chest in a square opening; and
the test device comprises an electromagnetic pulse emitting device arranged in an incident direction of the square incident bar, a static pre-stress applying device arranged in an output direction of the square transmission bar, and stress detecting elements respectively arranged on the X₊ direction, Y₊ direction, Z₊ direction, X₋ direction, Y₋ direction and Z₋ direction square bars used for measuring stress wave signal data.
the test method comprises the following steps:
step 1: quantitatively designing and preparing a cubic porous rock sample required by testing;
step 2: placing the cubic pore rock sample in the central cubic square chest, wherein the central cubic square chest and the horizontal cross supporting platform form an orthogonal coordinate system for accurately positioning and centering the dynamic true triaxial electromagnetic Hopkinson bar and six surfaces of the cubic porous rock sample; and
step 3: quantitatively studying a stress wave propagation law of the porous rock on the cubic porous rock sample by adopting the dynamic true triaxial electromagnetic Hopkinson bar test system, wherein:
in the step 1, a method for quantitatively designing and preparing a cubic porous rock sample required by testing comprises:
step 101: establishing a sample three-dimensional model data plane: establishing a cubic three-dimensional model with arbitrary spatial distribution of pores with a set shape based on a MATLAB programming tool, and acquiring a file containing sample three-dimensional model data plane information;
step 102: converting the sample three-dimensional model data plane into a three-dimensional solid: converting the sample three-dimensional model data plane of the file into the three-dimensional solid, and processing the three-dimensional solid to obtain a qualified sample three-dimensional solid model containing pores; and
step 103: performing slicing and 3D printing processing of the model: slicing the processed file of the sample three-dimensional solid model, setting a non-porous medium part in the sample to be cured and a porous medium part to be non-cured, acquiring a code file which is recognized by a 3D printer, and then inputting the code file to the 3D printer for 3D printing, and finally obtaining the cubic porous rock sample for experimental testing.

2. The test method according to claim 1, wherein the electromagnetic pulse emitting device comprises first confining pressure loading frames respectively arranged in incident directions of the X₊ direction, Y₊ direction and Z₊ direction square incident bars and are connected in series with the first boss, the first confining pressure loading frame is provided with an electromagnetic pulse excitation cavity, the electromagnetic pulse excitation cavity is capable of applying a high-amplitude dynamic stress wave to the square incident bar and is sequentially transferred to a sample to be tested and the square transmission bars through the square incident bars; and
the static pre-stress applying device comprises a confining pressure loading cylinder, a confining pressure loading actuator and a second confining pressure loading frame, the confining pressure loading cylinder and the confining pressure loading actuator are respectively combined in series with the second confining pressure loading frame, and the second confining pressure loading frame is connected in series with a second boss for transferring an acting force of the confining pressure loading cylinder to the square bars and a sample for testing.

3. The test method according to claim 2, wherein the stress detecting element is a strain gauge or a strain sensor.

4. The test method according to claim 2, wherein in the step 3, a method for quantitatively studying the stress wave propagation law of the porous rock on the cubic porous rock sample by adopting the dynamic true triaxial electromagnetic Hopkinson bar test system comprises:
step 301: placing an X₊ direction electromagnetic pulse excitation cavity and an X₊ direction electromagnetic pulse excitation cavity supporting frame in an X₊ direction confining pressure loading frame, and placing the same at an incident end of the X₊ direction square incident bar to ensure that the X₊ direction electromagnetic pulse excitation cavity is closely attached to the incident end of the square incident bar, and make the square incident bar and the square transmission bar be closely attached to the sample near the cubic porous rock sample side, in the case of not applying a static pre-stress, applying a high-amplitude dynamic stress wave by using the X₊ direction electromagnetic pulse excitation cavity, and using the stress detecting elements on the X₊ direction square incident bar and the X₋ direction square transmission bar to record and save complete stress wave signal data in the X direction after applying the high-amplitude dynamic stress wave under the condition of not applying a static pre-stress, and similarly carrying out same operations on Y and Z directions to acquire complete stress wave signal data in the Y and Z directions after applying a high-amplitude dynamic stress wave under the condition of not applying a static pre-stress;
step 302: applying a static pre-stress, opening a high-pressure oil pipe, charging oil into an X₋ direction confining pressure loading cylinder through an oil inlet, and pushing an X₋ direction confining pressure loading actuator to move forward and contact with an X₋ direction confining pressure loading frame; and continuously applying an oil pressure to push the X₋ direction confining pressure loading actuator to move forward, transferring an axial pressure to the X₋ direction square transmission bar through an X₋ direction second boss, and then acting on the cubic porous rock sample, so that the cubic porous rock sample is statically pre-stressed in the X direction, similarly, static confining pressure loading principles in the Y and Z directions being the same as that in the X direction; and
step 303: applying a high-amplitude dynamic stress wave to the X₊ direction, Y₊ direction and Z₊ direction electromagnetic pulse excitation cavities respectively to acquire stress the complete wave signal data in the X, Y and Z directions after applying the high-amplitude dynamic stress wave under the condition of applying a static pre-stress.

5. The test method according to claim 4, further comprising step 304: adjusting an amplitude of the dynamic stress wave and/or the static pre-stress respectively, and analyzing different high-amplitude stress wave propagation and attenuation laws in a certain cubic porous rock sample based on the complete stress wave signal data in the X, Y and Z directions acquired under the conditions of not applying a static pre-stress and applying a static pre-stress more than once.

6. The test method according to claim 5, further comprising step 305: switching different cubic porous rock samples, and returning to execute steps 301-304 to analyze the high-amplitude stress wave propagation and attenuation laws of a plurality of porous rocks in multiple dimensions by using a plurality of groups of stress wave signals.

7. The test method according to claim 4, wherein in the step 301, a processing manner for applying the high-amplitude dynamic stress wave to the X₊ direction comprises:
applying a high-amplitude dynamic stress wave to the sample for testing at the incident end of the X₊ direction square incident bar, wherein the dynamic stress wave is transmitted to the X₊ direction square incident bar as an X₊ direction stress wave via a left end face of the X₊ direction square incident bar, and then the X₊ direction stress wave is propagated from the X₊ direction to the X₋ direction to the cubic porous rock sample along an axis direction of the X₊ direction square incident bar and propagated to the X₋ direction square transmission bar as an X₋ direction transmitted stress wave; after receiving the X₋ direction transmitted stress wave, the X₋ direction square transmission bar moves backward and hits the X₋ direction square buffer bar, and transfers energy to the X₋ direction square buffer bar at the same time; the X− direction square buffer bar moves backward and hits an X₋ direction energy absorbing and buffering device therebehind, and the X₋ direction energy absorbing and buffering device absorbs all the energy to prevent the X₋ direction square buffer bar from moving in an opposite direction and hitting the X₋ direction square transmission bar, thus completing one complete X direction loading.

8. The test method according to claim 7, wherein for the collected data, a reflection coefficient of each impact in three directions is calculated according to a formula
$$R = \frac{{A}_{r}}{{A}_{0}} ,$$
wherein A₀ is an amplitude of an incident wave signal, and Aᵣ is an amplitude of a reflected wave signal; a transmission coefficient of each impact in three directions is calculated according to a formula
$$T = \frac{{A}_{t}}{{A}_{0}} ,$$
wherein Aₜ is an amplitude of a transmitted wave signal; meanwhile, the transmitted wave signals in three directions are respectively imported into Python or MATLAB software for frequency analysis; firstly, the signals are normalized, a window function after normalization is selected according to signal characteristics, then the data are subjected to windowing, and fast Fourier transform is carried out on the data after windowing to convert the data in original time domain of the transmitted signals into data in frequency domain, and data of positive axis is intercepted for drawing to understand distribution and change laws of transmitted wave energy in a frequency range.

9. The test method any according to claim 1-8, wherein in the step 101, a code for generating the cubic porous rock sample three-dimensional model is written by using the MATLAB programming tool, the MATLAB programming tool is preset with a series of parameters for controlling the rock sample, and through the setting of the parameters, a corresponding STL format file of the sample three-dimensional model data plane is obtained to realize accurate quantitative control of the porous medium characteristic of the cubic porous rock sample, wherein the parameters comprise one or all of a size of the cubic porous rock sample, a shape of the pore inside the sample, a pore size, spatial distribution, a size range and a porosity.

10. The test method according to claim 9, wherein the shape of the pore inside the sample comprises a spherical shape, a coin shape, an ellipsoid shape, a polyhedron shape or an irregular anisotropic shape, and when the shape of the pore is the spherical shape, a method for generating the cubic porous rock sample three-dimensional model STL file comprises the following steps:
A1: starting, and acquiring the input parameters for controlling the rock sample;
A2: generating three-dimensional data of the rock sample with corresponding shape and size;
A3: generating corresponding spherical pore spherical data according to the input parameters;
A4: calculating a porosity, determining whether the porosity is within a set interval, if yes, deriving porous data and then executing step A5, if not, returning to executing step A3; and
A5: exporting the porous data, and writing the three-dimensional data of the rock sample and the porous data into the STL format file, and ending.
